(19) United States
(12) Patent Application Publication
(10) Pub. No.: US 2025/0269498 A1
(43) Pub. Date: Aug. 28, 2025

(54) QUICK ADJUST KNOB FOR TRADITIONAL PIPE WRENCH

(71) Applicant: Klein Tools, Inc., Lincolnshire, IL (US)

(72) Inventors: Soo In Ma, Mansfield, TX (US); James E. Murphy, Baronville, TX (US); Eric S. Cheung, Mansfield, TX (US)

(73) Assignee: Klein Tools, Inc., Lincolnshire, IL (US)

(21) Appl. No.: 19/066,140

(22) Filed: Feb. 27, 2025

Related U.S. Application Data
(60) Provisional application No. 63/558,523, filed on Feb. 27, 2024.

(51) Int. Cl. B25B 13/50

(52) U.S. Cl. CPC B25B 13/5058

(57) ABSTRACT

A pipe wrench includes the quick adjust knob, a handle, a first jaw carried on the handle, and a hook-shaped movable member mounted on the handle to translate relative to the handle and the first jaw. The quick adjust knob includes a housing, a pair of floating threads, and a pair of actuating buttons configured to actuate the floating threads out of engagement with mating threads on the moveable member to allow the movable member to be quickly adjusted relative to the handle.

### CROSS-REFERENCE TO RELATED APPLICATIONS

This application claims priority to provisional U.S. Patent Application No. 63/558,523 filed Feb. 27, 2024, the entire disclosure of which is incorporated herein by reference.

### BACKGROUND OF THE DISCLOSURE

The present disclosure relates to tools, and more particularly, to a traditional pipe wrench's that are sometimes referred to as a “monkey wrench”.

Traditional pipe wrenches include an moveable jaw that is adjustable by a user retaining an adjustment knob having internal threads that engage an eternally threaded feature extending from the movable jaw. While this works satisfactorily for its intended purpose, it can be time consuming and burdensome to make large adjustments in the movable jaw when attempting to work on pipes that have significantly different diameters. Accordingly, there is always room for improvement.

### BRIEF SUMMARY OF THE DISCLOSURE

According to one feature of this disclosure,

In accordance with one feature of this disclosure, a pipe wrench includes a handle; a first jaw on the handle; a movable member mounted on the handle to translate relative to the handle and the first jaw, the movable member carrying a second jaw and having an elongate shank with external screw threads formed on a pair of oppositely facing sides of the shank; and a quick adjust knob carried on the shank and engageable with the handle. The quick adjust knob includes a housing; a pair of floating threads mounted in the housing opposite each other for selective engagement with the external screw threads on the shank, each of the floating members being spring biased into engagement with the external screw threads on the shank; and a pair of actuating buttons mounted in the housing opposite each other, the actuating buttons engaged with the floating threads to actuate the floating threads away from each other and out of engagement with the external screw threads on the shank in response to the actuating buttons being pushed toward each other.

As one feature, each of the actuating buttons has a pair of circumferentially spaced ramp surfaces, with one of the ramp surfaces engaged with a corresponding surface on one of the floating threads and the other of the ramp surfaces engaged with another corresponding surface on the other of the floating threads. The ramp and corresponding surfaces cooperate to actuate the floating threads away from each other and out of engagement with the external screw threads on the shank in response to the actuating buttons being pushed toward each other.

In one feature, each of the actuating buttons includes internal threads for engagement with the external threads on the shank, the internal threads and the floating threads cooperating with the external threads on the shank to adjust the position of the second jaw relative to the first jaw in response to the quick adjust knob being rotated relative to the shank.

According to one feature, the shank has a pair of faces extending between the oppositely facing sides, with each of the faces being free of any screw threads.

As one feature, the quick adjust knob further includes a pair of compression springs, each of the springs sandwiched between a corresponding one of the floating threads and the housing to bias the floating thread toward the other floating thread.

In one feature, the quick adjust knob further includes a pair of end caps spaced by the housing, each of the end caps attached to a corresponding open end of the housing and having a central opening to allow passage of the shank through the end cap, In a further feature, at least one of the end caps having at least one guide rail engaged with a corresponding guide groove on at least one of the floating threads and actuating button. In yet a further feature, at least one of the end caps has four guide rails, each of the guide rails engaged with a corresponding guide groove on a corresponding one of the floating threads and actuating buttons.

According to one feature, the handle includes a pair of spaced receiving structures that receive the shank of the movable member. In a further feature, the quick adjust knob is carried on the shank between the pair of spaced receiving structures.

### BRIEF SUMMARY OF THE SEVERAL VIEWS OF THE DRAWINGS

FIG. 1 a side view of a pipe wrench incorporating a quick adjust knob according to this disclosure;

FIG. 2 is a view taken from line 2-2 in FIG. 1 and showing a pair of actuating buttons of the quick adjust knob in an “at rest” condition or state;

FIG. 3 is a view identical to FIG. 2 but showing the pair of actuating buttons in an actuated condition or state;

FIG. 4 is a side view of a moveable member and jaw of the pipe wrench of FIGS. 1-3;

FIG. 5 is a side view of a handle and jaw of the pipe wrench of FIGS. 1-3;

FIGS. 6 and 7 are perspective views of the handle and jaw of FIG. 5;

FIG. 8 is a perspective view of the quick adjust knob of FIGS. 1-3;

FIG. 9 is a somewhat diagrammatic exploded view of the quick adjust knob of FIG. 8;

FIG. 10 is a view taken from line 10-10 in FIG. 1 and showing the pair of actuating buttons of the quick adjust knob in an “at rest” condition or state;

FIG. 11 is a view taken from line 11-11 in FIG. 1 and the pair of actuating buttons of the quick adjust knob in an “at rest” condition or state;

FIG. 12 is a partially broken, perspective view again showing the pair of actuating buttons of the quick adjust knob in an “at rest” condition or state

FIG. 13 is view taken from line 10-10 in FIG. 1 and showing the pair of actuating buttons of the quick adjust knob in an “at rest” condition or state;

### DETAILED DESCRIPTION OF PREFERRED EMBODIMENTS

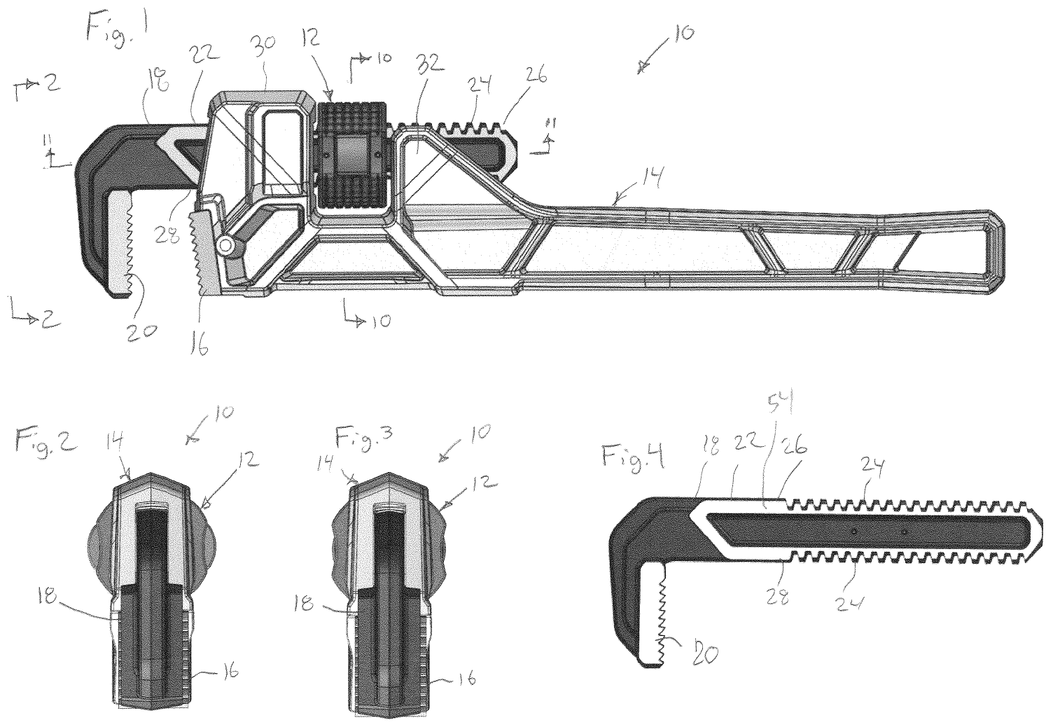

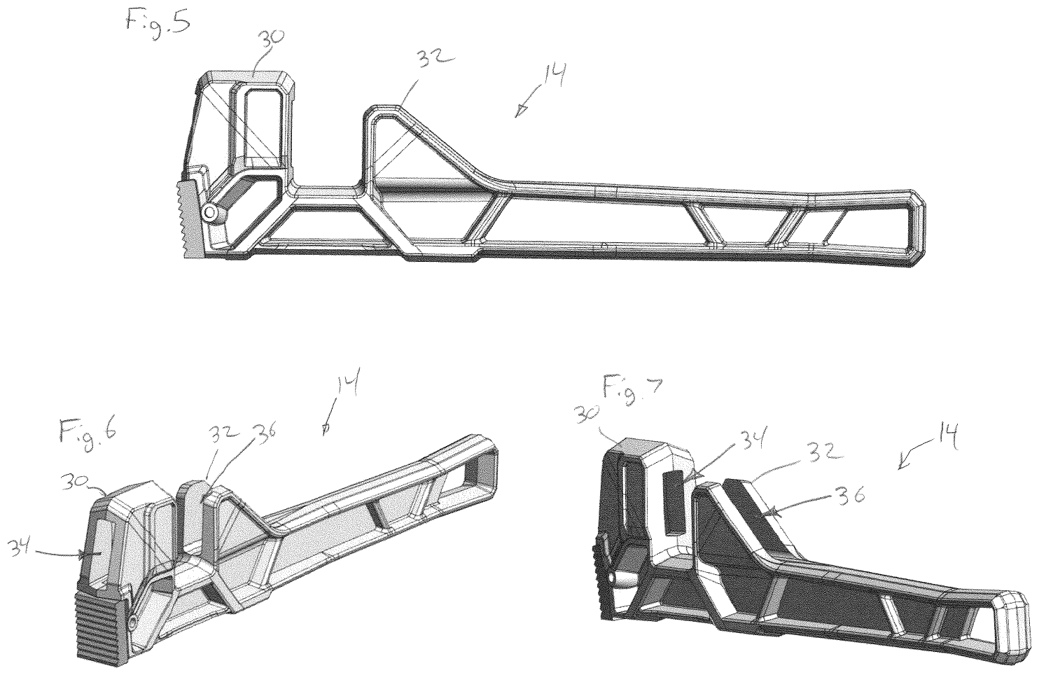

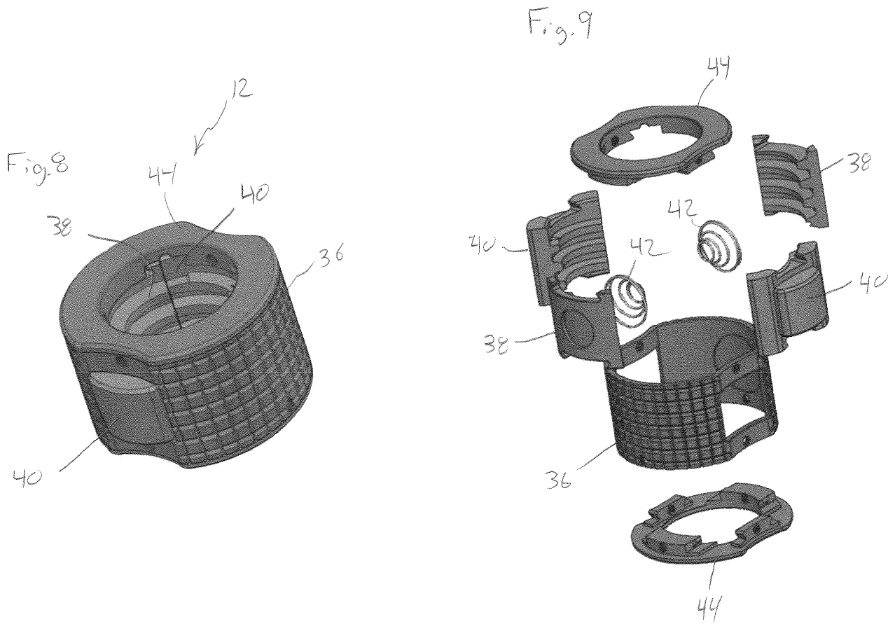

With reference to FIG. 1-3, a pipe wrench 10 is shown incorporating a quick adjust knob 12 according to this disclosure. The pipe wrench 10 includes the quick adjust knob 12, a handle 14, a first jaw 16 carried on the handle 14, and a hook-shaped movable member 18 mounted on the handle 14 to translate relative to the handle and the first jaw 16. As best seen in FIG. 4, the movable member 18 includes a second jaw 20 and an elongate shank 22. The elongate shank 22 includes external screw threads or teeth 24 formed on a pair of oppositely facing sides 26 and 28 of the shank 22.

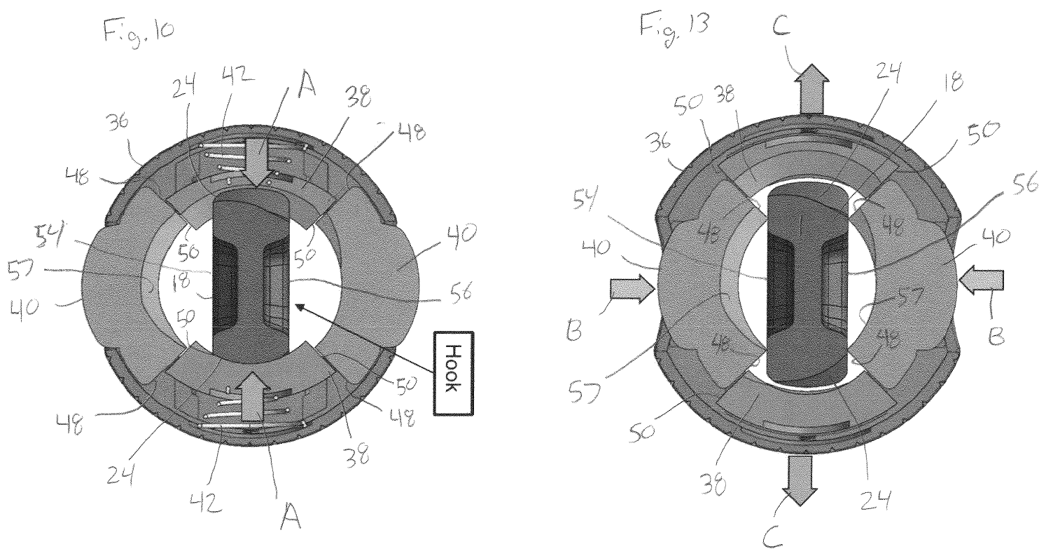

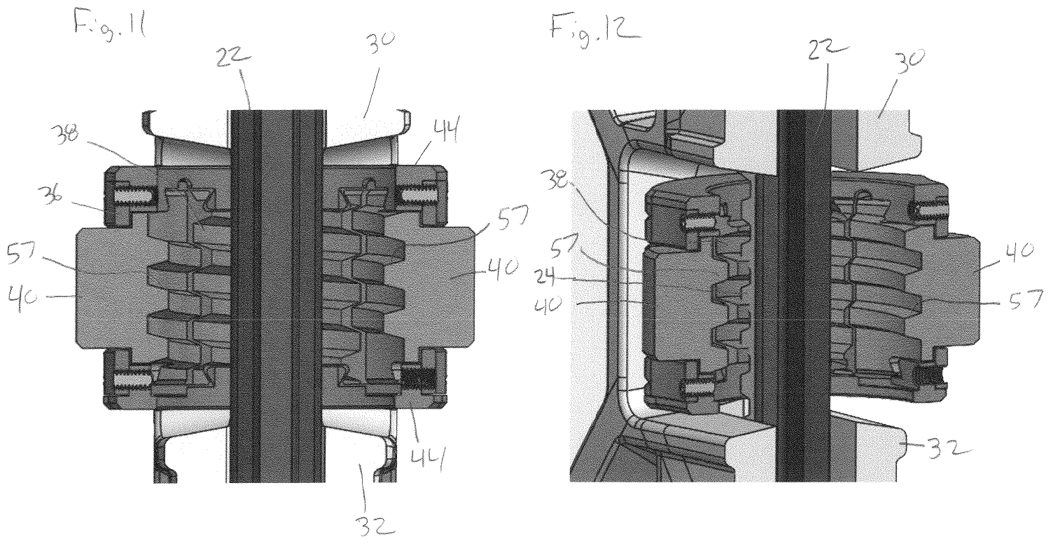

As best seen in FIGS. 1 and 5-8, the handle 14 includes a pair of spaced receiving structures 30 and 32 that receive the shank 22 of the movable member 18. The receiving structure 30 includes a rectangular shaped through opening 34 through which the shank 22 extends. The receiving structure 32 includes an open sided channel 36 through which the shank 22 extends. As best seen in FIG. 1, the quick adjust knob 12 is carried on the shank 22 between the pair of receiving structures 30 and 32.

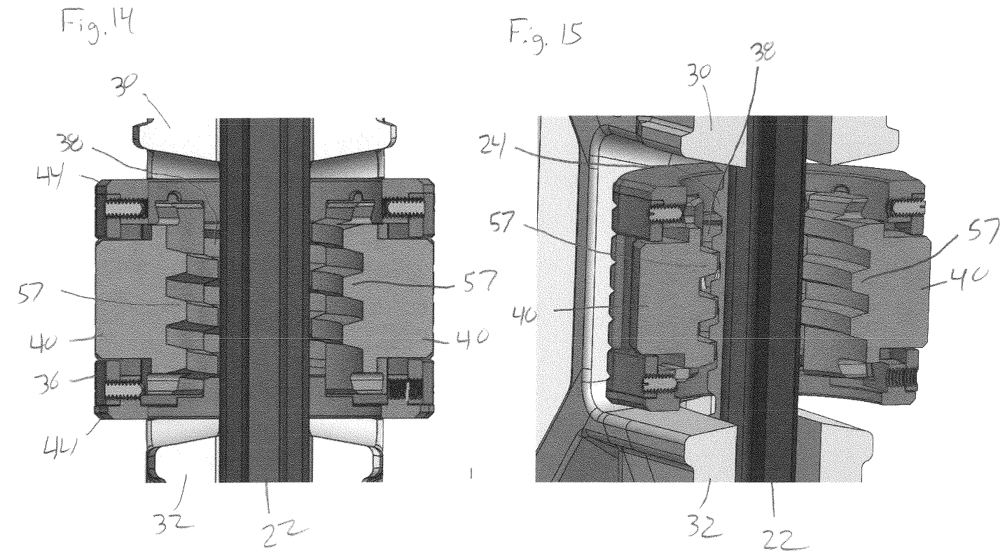

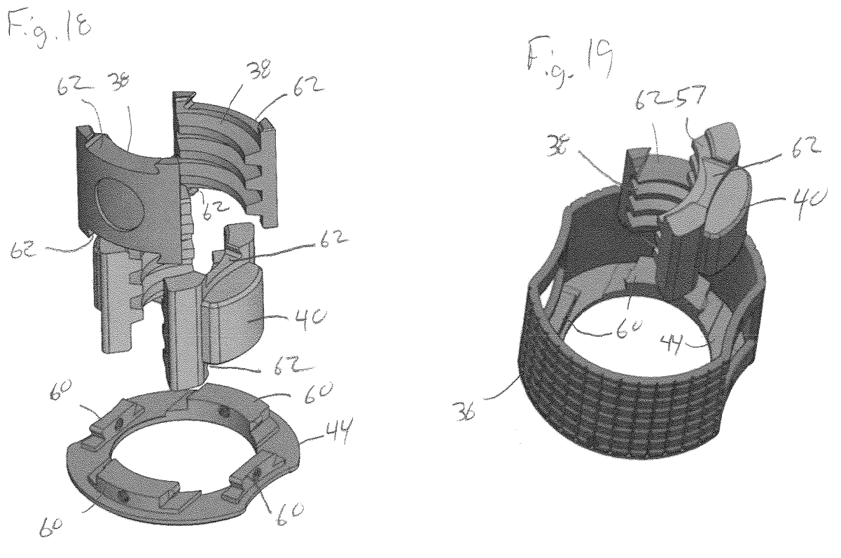

As best seen in FIGS. 9-14, in the illustrated embodiment, the quick adjust knob 12 includes a housing 36, a pair of floating threads 38, a pair of actuating buttons 40, a pair of springs in the form of variable compression springs 42, and a pair of end caps 44. As best seen in FIGS. 11-14, the floating threads 38 are mounted in the housing 36 opposite each other for selective engagement with the screw threads 24 on the shank 22, with each of the floating threads being spring biased into engagement with the screw threads 24 by the compression springs 42. In this regard, as best seen in FIG. 11, each of the springs 42 is sandwiched between the housing 36 and a corresponding one of the floating threads 38 to bias the floating threads 38 into engagement with the external threads 24 on the shank 18. In this “at rest” condition or state shown in FIGS. 11-13, a user can move the movable member 18 relative to the handle 14 by rotating the knob 12 either clockwise or counterclockwise about the shank 22 to accurately adjust the distance between the jaws 16 and 20, as is done in traditional pipe wrenches.

As best seen in FIGS. 11 and 14, the pair of actuating buttons 40 are mounted in the housing 36 opposite each other, with the actuating buttons 40 engaged with the floating threads 38 to actuate the floating threads 38 away from each other and out of engagement with the external screw threads 24 on the shank 22 in response to the actuating buttons 40 being pushed toward each other. In this regard, as best seen in FIGS. 11, 14, and 17, in the illustrated embodiment, each of the actuating buttons 40 has a pair of circumferentially spaced ramp surfaces 48, with one of the ramp surfaces 48 engaged with a corresponding surface 50 on one of the floating threads 38 and the other of the ramp surfaces 48 engaged with another corresponding surface 50 on the other of the floating threads 38. The ramp and corresponding surfaces 48 on the buttons 40 and floating threads 38 cooperate to actuate the floating threads 38 away from each other and out of engagement with the external screw threads 24 on the shank 22 in response to the actuating buttons 40 being pushed toward each other, as best illustrated by the arrows A for the buttons 40 and the arrows B for the floating threads 38 in FIG. 14 which shows the components in an actuated condition or state. This allows a user to freely move/adjust the movable member 18 relative to the handle 14 to quickly adjust the distance between the jaws 16 and 20. In this regard, as best seen in FIGS. 14-16, the shank 22 has a pair of faces 54 and 56 extending between the oppositely facing sides 26 and 28, with each of the faces 54 and 56 being free of any screw threads.

As best seen in FIG. 17, in the illustrated embodiments, the ramp surfaces 48 and corresponding surfaces 50 are 45 degrees for optimal performance while keeping the overall envelope small. This can be alternated to +or −15 degrees as needed, but it will increase the housing size as a result. These ramps aid in translation of motion between the actuating buttons 40 and the floating threads 38.

In the illustrated embodiments, each of the actuating buttons 40 includes internal threads 50 for engagement with the external threads 24 on the shank 18. The internal threads 50 and the floating threads 38 cooperate with the external threads 24 on the shank 22 to adjust the position of the second jaw 20 relative to the first jaw 16 in response to the knob 12 being rotated relative to the shank 18. In the illustrated embodiment, the floating threads 24 and the internal threads 50 both have the same profile and pitch for the threads but have different OD perimeters. More specifically, the threads 50 on the buttons 40 have identical teeth geometry and pitch height as the floating threads 24 but have a greater OD. This feature removes blind spots where the threads 24 on the shank 22 would not otherwise engage with the threads on the buttons 40 or the floating threads 38. This prevents the moveable member 18 from slipping in certain orientations.

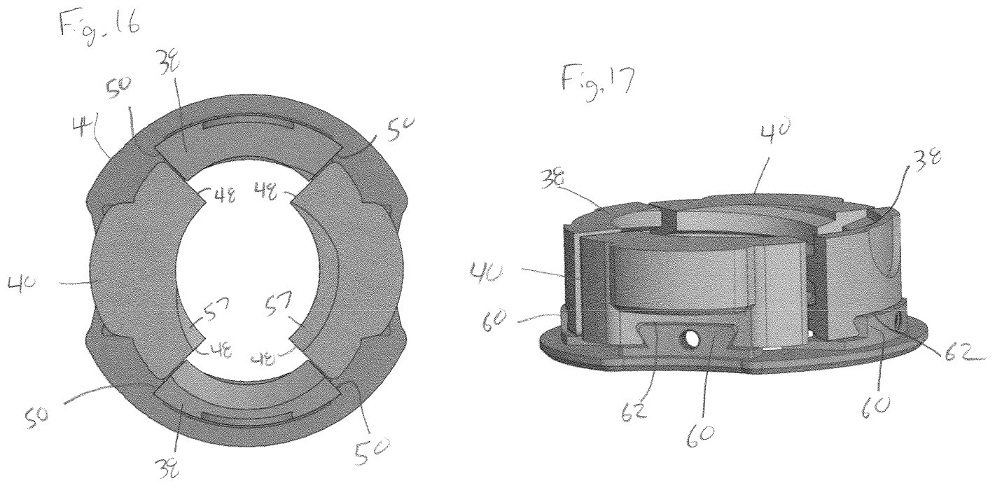

As best seen in FIGS. 10 and 18-20, in the illustrated embodiment, each of the end caps 44 include four dove tailed tracks or rails 50. Each of the actuating buttons 40 and floating threads 38 includes a conforming channel 52 that receives a corresponding one of the rails 50 to provide guided translation along the rail 50. Other geometries like ovals, circles, and rectangles can be used for the shape/geometry of the rails 50, with each providing pros and cons, but the illustrated dove-tail geometry is preferred because it allows for ease of overall assembly and has the least amount of vertical wobble.

1. A pipe wrench comprising:
a handle;
a first jaw on the handle;
a movable member mounted on the handle to translate relative to the handle and the first jaw, the movable member carrying a second jaw and having an elongate shank with external screw threads formed on a pair of oppositely facing sides of the shank; and
a quick adjust knob carried on the shank and engageable with the handle, the quick adjust knob comprising:
a housing;
a pair of floating threads mounted in the housing opposite each other for selective engagement with the external screw threads on the shank, each of the floating members being spring biased into engagement with the external screw threads on the shank; and
a pair of actuating buttons mounted in the housing opposite each other, the actuating buttons engaged with the floating threads to actuate the floating threads away from each other and out of engagement with the external screw threads on the shank in response to the actuating buttons being pushed toward each other.

2. The pipe wrench of claim 1 wherein each of the actuating buttons having a pair of circumferentially spaced ramp surfaces, with one of the ramp surfaces engaged with a corresponding surface on one of the floating threads and the other of the ramp surfaces engaged with another corresponding surface on the other of the floating threads, the ramp and corresponding surfaces cooperating to actuate the floating threads away from each other and out of engagement with the external screw threads on the shank in response to the actuating buttons being pushed toward each other.

3. The pipe wrench of claim 1 wherein each of the actuating buttons comprises internal threads for engagement with the external threads on the shank, the internal threads and the floating threads cooperating with the external threads on the shank to adjust the position of the second jaw relative to the first jaw in response to the quick adjust knob being rotated relative to the shank.

4. The pipe wrench of claim 1 wherein the shank has a pair of faces extending between the oppositely facing sides, each of the faces being free of any screw threads.

5. The pipe wrench of claim 1 wherein the quick adjust knob further comprises a pair of compression springs, each of the springs sandwiched between a corresponding one of the floating threads and the housing to bias the floating thread toward the other floating thread.

6. The pipe wrench of claim 1 wherein the quick adjust knob further comprises a pair of end caps spaced by the housing, each of the end caps attached to a corresponding open end of the housing and having a central opening to allow passage of the shank through the end cap.

7. The pipe wrench of claim 6 wherein at least one of the end caps having at least one guide rail engaged with a corresponding guide groove on at least one of the floating threads and actuating button.

8. The pipe wrench of claim 7 wherein at least one of the end caps has four guide rails, each of the guide rails engaged with a corresponding guide groove on a corresponding one of the floating threads and actuating buttons.

9. The pipe wrench of claim 1 wherein the handle comprises a pair of spaced receiving structures that receive the shank of the movable member.

10. The pipe wrench of claim 9 wherein the quick adjust knob is carried on the shank between the pair of spaced receiving structures.
